(19) United States
(12) Patent Application Publication
(10) Pub. No.: US 2026/0066346 A1
(43) Pub. Date: Mar. 5, 2026

(54) ELECTROLYTE, ELECTROCHEMICAL APPARATUS, AND ELECTRONIC APPARATUS

(71) Applicant: Ningde Amperex Technology Limited, Ningde (CN)

(72) Inventors: Ben WANG, Ningde (CN); Shaoyun ZHOU, Ningde (CN); Xianhai LU, Ningde (CN); Junhua JIAN, Ningde (CN)

(73) Assignee: Ningde Amperex Technology Limited, Ningde (CN)

(21) Appl. No.: 19/313,885

(22) Filed: Aug. 29, 2025

(30) Foreign Application Priority Data
Aug. 30, 2024 (CN) 202411208219.0

(51) Int. Cl. H01M 10/0567; H01G 11/64; H01M 10/0525

(52) U.S. Cl. CPC H01M 10/0567; H01M 10/0525; H01G 11/64; H01M 2300/0025

(57) ABSTRACT

An electrolyte includes lithium tetrafluoroborate and a compound of Formula I

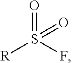

where a mass percentage A of the lithium tetrafluoroborate satisfies 0.1%≤A≤2%, and a mass percentage B of the compound of Formula I satisfies 0.010%≤B≤20%.

### CROSS-REFERENCE TO RELATED APPLICATION

This application claims the benefit of priority from the Chinese Patent Application No. 202411208219.0, filed on Aug. 30, 2024, the entire content of which is incorporated herein by reference.

### TECHNICAL FIELD

The present application relates to the technical field of electrochemical apparatuses, and in particular, to an electrolyte, an electrochemical apparatus, and an electronic apparatus.

### BACKGROUND

Electrochemical apparatuses have advantages such as high energy storage density, high open-circuit voltage, low self-discharge rate, long cycle life, and good safety, and are widely used in various fields such as portable energy storage, electronic apparatuses, and electric vehicles. However, there are also higher requirements for the comprehensive performance of electrochemical apparatuses, such as simultaneously having high energy density, good high-temperature storage performance, and cycling performance. Improving the components of the electrolyte can improve the stability of the protective films formed at the positive and negative electrode interfaces, thereby improving the high- and low-temperature performance of the electrochemical apparatus. However, in related technologies, the effect of the electrolyte on improving the stability of the protective films at the positive and negative electrode interfaces is still suboptimal. Therefore, it is necessary to optimize the components of the electrolyte.

### SUMMARY

Embodiments of the present application provide an electrolyte, an electrochemical apparatus, and an electronic apparatus, capable of addressing the issue of poor stability of the protective films at the positive and negative electrode interfaces caused by the electrolyte.

According to a first aspect, the present application provides an electrolyte including lithium tetrafluoroborate and a compound of Formula I;

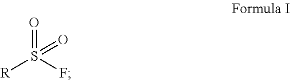

where R in the compound of Formula I is selected from unsubstituted or Ra-substituted C₂-C₆ alkyl, unsubstituted or Ra-substituted C₂-C₆ alkenyl, unsubstituted or Ra-substituted C₂-C₆ alkynyl, unsubstituted or Ra-substituted C₂-C₆ nitrogen-containing heteroaryl, or unsubstituted or Ra-substituted C₆-C₁₂ aryl, where each group substituent Ra is independently selected from fluorine or C₁-C₆ fluoroalkyl; and
based on a total mass of the electrolyte, a mass percentage of the lithium tetrafluoroborate is A, and a mass percentage of the compound of Formula I is B, where 0.1%≤A≤2%, and 0.01%≤B≤20%. By regulating the electrolyte to include the compound of Formula I and lithium tetrafluoroborate, with the mass percentages of the compound of Formula I and lithium tetrafluoroborate within the ranges of the present application, the stability of the electrode plate interface can be effectively enhanced, the impedance of the electrochemical apparatus can be improved, and the low-temperature discharge performance of the electrochemical apparatus can be enhanced.

In some exemplary embodiments, the electrolyte satisfies at least one of the following conditions:

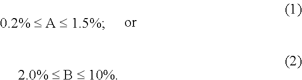

In some exemplary embodiments, 15≤B/A≤70. By selecting the percentages of lithium tetrafluoroborate and the compound of Formula I to satisfy the above ranges, the synergistic effect of lithium tetrafluoroborate and the compound of Formula I is more pronounced, capable of improving the impedance at the positive and negative electrode interfaces, forming a thin passivation layer, and effectively improving the ionic conductivity at the electrode plate interface.

In some exemplary embodiments, the compound of Formula I includes at least one of the following compounds:

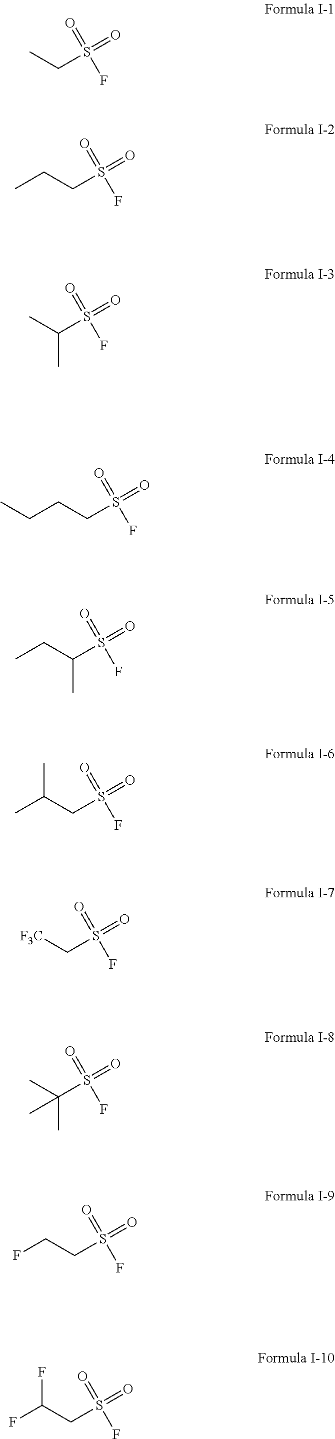

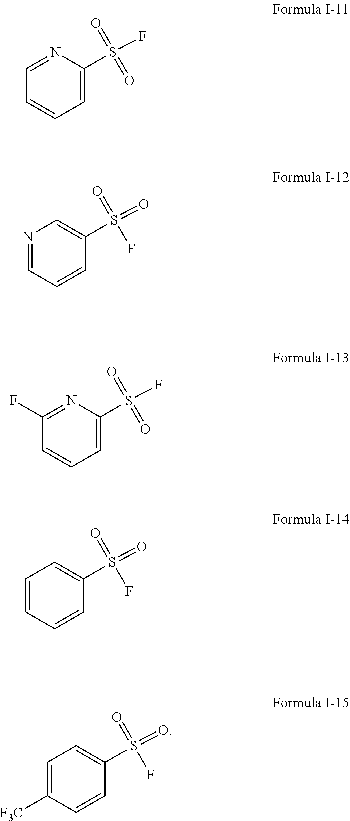 [SMILES: O=S(=O)(F)c1ccccn1 ; O=S(=O)(F)c1cccnc1 ; O=S(=O)(F)c1cccc(F)n1 ; O=S(=O)(F)c1ccccc1 ; O=S(=O)(F)c1ccc(C(F)(F)F)cc1]

By selecting the above compound of Formula I, the compound of Formula I can form a positive electrode interface passivation layer and/or a negative electrode interface passivation layer of lithium-containing inorganic compounds rich in S and F elements at the electrode interface, enhancing the stability of the positive and negative electrode interfaces, improving the impedance of the electrochemical apparatus, increasing ionic conductivity, and thereby improving the low-temperature discharge performance of the electrochemical apparatus.

In some exemplary embodiments, the electrolyte further includes a compound of Formula II, the compound of Formula II including at least one of the following compounds:

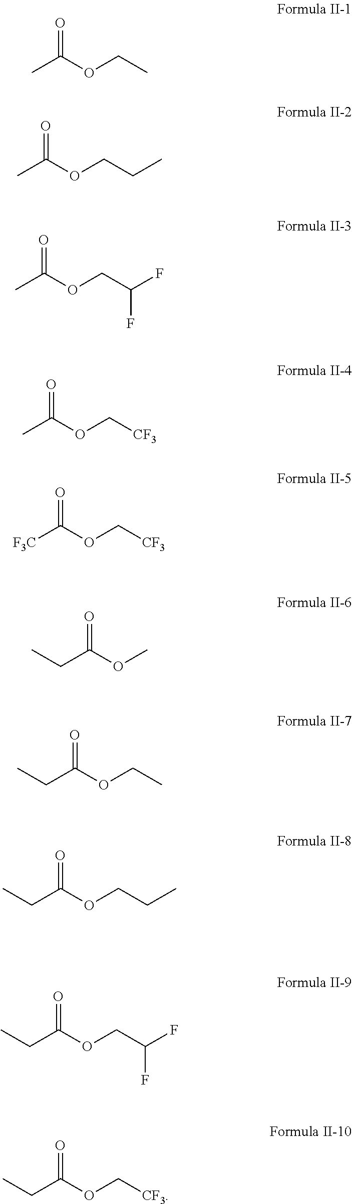

In some exemplary embodiments, based on the total mass of the electrolyte, a mass percentage of the compound of Formula II is C, where 0.1%≤C≤20%. The compound of Formula II is a carboxylate compound with low viscosity, low melting point, and high dielectric constant. By adjusting the mass percentage of the compound of Formula II in the electrolyte to satisfy the above range and using it as a co-solvent with the compound of Formula I, the ionic conductivity of the electrolyte at low temperatures can be increased, thereby further improving the low-temperature performance of the electrochemical apparatus.

In some exemplary embodiments, the electrolyte further includes a fluorinated carbonate, the fluorinated carbonate including at least one of fluoroethylene carbonate, difluoroethylene carbonate, or 3,3,3-trifluoropropylene carbonate. Based on the total mass of the electrolyte, a mass percentage of the fluorinated carbonate is F, where 0.01%≤F≤5%, and 0.005≤F/(A+B)≤0.5. By selecting the mass percentage of the fluorinated carbonate within the above range, the fluorinated carbonate can further improve the impedance at the negative electrode interface, improving the low-temperature discharge performance of the electrochemical apparatus. Additionally, the fluorinated carbonate, in combination with the compound of Formula I and lithium tetrafluoroborate, can increase the dissociation degree of lithium tetrafluoroborate due to the high dielectric constants of the fluorinated carbonate and the compound of Formula I, thereby improving the low-temperature discharge performance of the electrochemical apparatus.

In some exemplary embodiments, the electrolyte further includes a cyclic sulfur-oxygen double bond compound, the cyclic sulfur-oxygen double bond compound including at least one of 1,3-propane sultone, ethylene sulfate, or methylene methanedisulfonate. Based on the total mass of the electrolyte, the mass percentage of the cyclic sulfur-oxygen double bond compound is S, where 0.01%≤S≤5.0%, and 0.003≤S/(A+B)≤0.5. By selecting the mass percentage of the cyclic sulfur-oxygen double bond compound to satisfy the above range, the cyclic sulfur-oxygen double bond compound can further enrich the components at the positive and negative electrode interfaces during the charge-discharge process, increasing the density of the passivation layer. Additionally, the cyclic sulfur-oxygen double bond compound, in combination with the compound of Formula I and lithium tetrafluoroborate, can improve the ionic conductivity of the electrolyte at low temperatures due to the solvation structure formed by the cyclic sulfur-oxygen double bond compound and the compound of Formula I with lithium ions.

According to a second aspect, the present application provides an electrochemical apparatus including the electrolyte as described above.

According to a third aspect, the present application provides an electronic apparatus including the electrochemical apparatus as described above.

Based on the electrolyte, electrochemical apparatus, and electronic apparatus of some embodiments of the present application, by adding lithium tetrafluoroborate and the compound of Formula I to the electrolyte, and selecting the mass percentage A of lithium tetrafluoroborate to satisfy 0.1%≤A≤2% and the mass percentage B of the compound of Formula I to satisfy 0.01%≤B≤20%, lithium tetrafluoroborate can form, with the compound of Formula I, a passivation layer including organic components and inorganic components and being rich in at least one element among B, P, or F. The passivation layer is thin and robust, and exists at the positive electrode interface and/or the negative electrode interface, effectively enhancing the stability of the electrode plate interface, improving the impedance of the electrochemical apparatus, and improving the low-temperature discharge performance of the electrochemical apparatus.

The passivation layer in the present application also refers to the protective film layer formed at the positive and/or negative electrode interface.

### DETAILED DESCRIPTION

The technical solutions in some embodiments of the present application will be clearly and completely described below. It is apparent that the described embodiments are only some embodiments of the present application, rather than all embodiments. All other embodiments obtained by those skilled in the art based on the present application fall within the protection scope of the present application.

It should be noted that an example in which a lithium-ion battery is used as an electrochemical apparatus is used to illustrate the present application below. However, the electrochemical apparatus in the present application is not limited to the lithium-ion battery. The specific technical solutions are as follows:

According to a first aspect, the present application provides an electrolyte for an electrochemical apparatus, the electrolyte including lithium tetrafluoroborate and a compound of Formula I. Based on a total mass of the electrolyte, a mass percentage A of the lithium tetrafluoroborate satisfies 0.1%≤A≤2%, and a mass percentage B of the compound of Formula I satisfies 0.01%≤B≤20%, capable of forming a thin and robust passivation layer at the positive and negative electrode interfaces, thereby improving the impedance and low-temperature discharge performance of the positive and negative electrode interfaces.

The compound of Formula I included in the electrolyte of the present application is as follows:

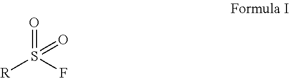

where R in Formula I is selected from unsubstituted or Ra-substituted C₂-C₆ alkyl, unsubstituted or Ra-substituted C₂-C₆ alkenyl, unsubstituted or Ra-substituted C₂-C₆ alkynyl, unsubstituted or Ra-substituted C₂-C₆ nitrogen-containing heteroaryl, or unsubstituted or Ra-substituted C₆-C₁₂ aryl, where each group substituent Ra is independently selected from fluorine or C₁-C₆ fluoroalkyl.

In some embodiments of the present application, by adding the compound of Formula I to the electrolyte, the compound of Formula I can form a positive electrode interface passivation layer and/or a negative electrode interface passivation layer of lithium-containing inorganic compounds rich in S and F elements at the electrode interface, enhancing the stability of the positive and negative electrode interfaces, improving the impedance of the electrochemical apparatus, increasing ionic conductivity, and thereby improving the low-temperature discharge performance of the electrochemical apparatus.

Based on the mass of the electrolyte, the mass percentage of the compound of Formula I is B, and in some embodiments, 0.01%≤B≤20%. In some embodiments, 1.0%≤B≤15%. In some embodiments, 2.0%≤B≤10%. In some embodiments, 2.0%≤B≤5%. In some embodiments, 0.05%≤B≤10%. In some embodiments, the value of B is 0.01%, 0.03%, 0.05%, 0.07%, 1.0%, 8.0%, 10.0%, 13.0%, 18%, 20%, or a value within a range formed by any two of these values. By selecting B within the above ranges, the percentage of the compound of Formula I is appropriate, which helps promote the uniform deposition of compounds containing elements such as S and F at the positive electrode interface, while increasing the ionic conductivity of the positive electrode interface and reducing the impedance of the positive electrode interface. When B exceeds the upper limit of 20%, the thickness of the passivation layer formed at the positive electrode interface increases, reducing ionic conductivity and worsening impedance, thereby reducing the ionic conductivity of the positive electrode interface. When B is below the lower limit of 0.01%, it is difficult to achieve the effect of improving interface impedance.

In some embodiments, the compound of Formula I includes at least one of the following compounds:

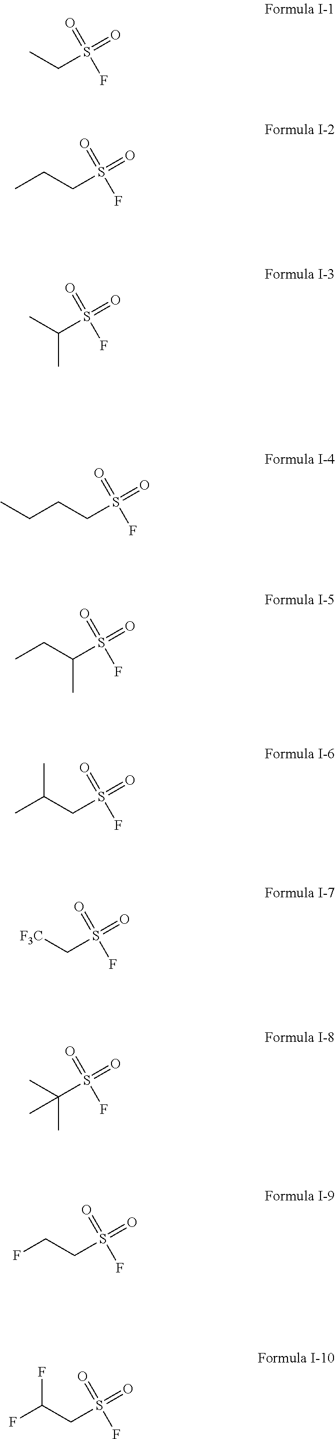

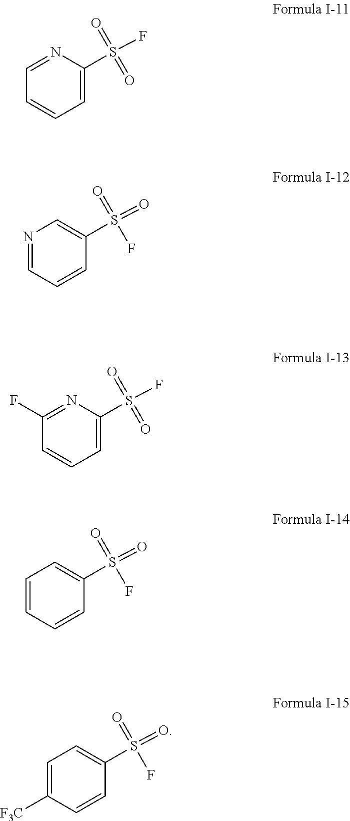 [SMILES: O=S(=O)(F)c1ccccn1 ; O=S(=O)(F)c1cccnc1 ; O=S(=O)(F)c1cccc(F)n1 ; O=S(=O)(F)c1ccccc1 ; O=S(=O)(F)c1ccc(C(F)(F)F)cc1]

The electrolyte further includes lithium tetrafluoroborate, and the lithium tetrafluoroborate can form, with the compound of Formula I, a passivation layer including organic components and inorganic components and being rich in at least one element among B, P, or F. The passivation layer is thin and robust, and exists at the positive electrode interface or the negative electrode interface, effectively enhancing the stability of the electrode plate interface, improving the impedance of the electrochemical apparatus, and improving the low-temperature discharge performance of the electrochemical apparatus.

Based on the mass of the electrolyte, a mass percentage of the lithium tetrafluoroborate is A, and in some embodiments, 0.1%≤A≤2%. In some embodiments, the value of A is 0.1%, 0.2%, 0.3%, 0.5%, 0.7%, 1.0%, 1.2%, 1.5%, 1.8%, 2.0%, or a value within a range formed by any two of these values. In some embodiments, 0.3%≤A≤2%. In some embodiments, 0.4%≤A≤1.8%. In some embodiments, 0.5%≤A≤2%. In some embodiments, 1.8%≤A≤2%. In the present application, A satisfying the above ranges further optimizes the percentage of lithium tetrafluoroborate, which can meet the requirement of optimizing the morphology of the positive and negative electrode interfaces by lithium tetrafluoroborate in conjunction with the compound of Formula I, while reducing the increase in impedance at the positive and negative electrodes due to excessive decomposition of lithium tetrafluoroborate itself. When A exceeds the upper limit of 10%, lithium tetrafluoroborate cannot be fully ionized, reducing the conductivity of the electrolyte. When A is below the lower limit of 0.3%, the percentage of B in the film-forming components is insufficient, making it difficult to achieve the effect of improving the interface.

In some embodiments, 15≤B/A≤70. In some embodiments, 15≤B/A≤65.0. In some embodiments, 20.0≤B/A≤60.0. In some embodiments, 25.0≤B/A≤60.0. In some embodiments, 20.0≤B/A≤65.0. In some embodiments, the value of B/A is 0.005, 5.0, 15.0, 26.8, 31.8, 41.0, 52.7, 73.4, 84.5, 95.0, or a value within a range formed by any two of these values. By regulating the value of B/A within the above ranges, the synergistic effect of lithium tetrafluoroborate and the compound of Formula I is more pronounced, capable of improving the impedance at the positive and negative electrode interfaces, forming a thin passivation layer, and effectively improving the ionic conductivity at the electrode plate interface.

In some embodiments, the electrolyte further includes a compound of Formula II, the compound of Formula II including at least one of the following compounds:

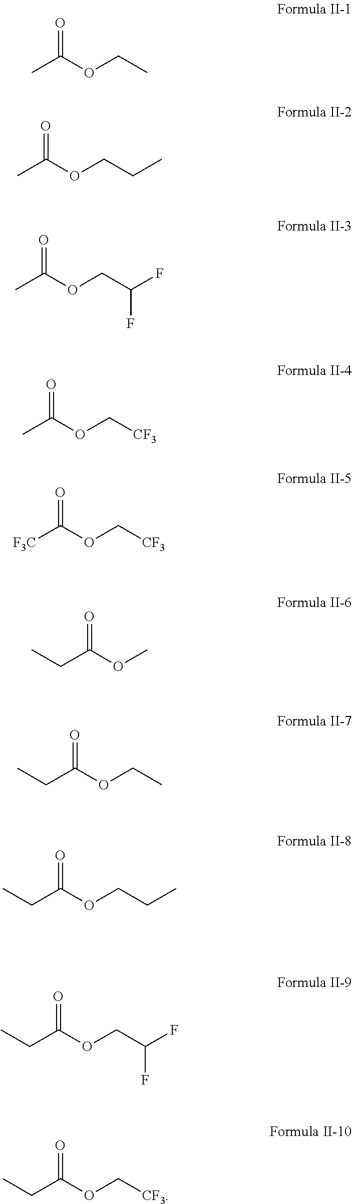

In some embodiments, based on the total mass of the electrolyte, a mass percentage of the compound of Formula II is C, where C satisfies: 0.1%≤C≤20%. In some embodiments, 0.1%≤C≤10%. In some embodiments, 0.5%≤C≤15.0%. In some embodiments, 0.5%≤C≤12.0%. In some embodiments, 1.0%≤C≤15.0%. In some embodiments, the value of C is 0.1%, 0.5%, 1.5%, 8.8%, 9.8%, 10.0%, 12.8%, 13.6%, 15.5%, 20.0%, or a value within a range formed by any two of these values. The compound of Formula II is a carboxylate compound with low viscosity, low melting point, and high dielectric constant. By adjusting the mass percentage of the compound of Formula II in the electrolyte to satisfy the above range and using it as a co-solvent with the compound of Formula I, the ionic conductivity of the electrolyte at low temperatures can be increased, thereby further improving the low-temperature performance of the electrochemical apparatus.

In some embodiments, the electrolyte further includes a fluorinated carbonate, the fluorinated carbonate including at least one of fluoroethylene carbonate, difluoroethylene carbonate, or 3,3,3-trifluoropropylene carbonate.

In some embodiments, based on the total mass of the electrolyte, a mass percentage of the fluorinated carbonate is F, where F satisfies: 0.01%≤F≤5.0%. In some embodiments, 0.1%≤F≤5.0%. In some embodiments, 0.5%≤F≤4.0%. In some embodiments, 0.9%≤F≤3.5%. In some embodiments, 0.1%≤F≤3.5%. In some embodiments, 0.9%≤F≤3%. In some embodiments, the value of F is 0.01%, 0.05%, 0.25%, 1.0%, 2.0%, 3.0%, 3.1%, 3.8%, 4.5%, 5.0%, or a value within a range formed by any two of these values. The fluorinated carbonate has good reduction properties. By selecting the percentage of the fluorinated carbonate within the above range, the fluorinated carbonate can further improve the impedance at the negative electrode interface, improving the low-temperature discharge performance of the electrochemical apparatus. Additionally, the fluorinated carbonate, in combination with the compound of Formula I and lithium tetrafluoroborate, can increase the dissociation degree of lithium tetrafluoroborate due to the high dielectric constants of the fluorinated carbonate and the compound of Formula I, thereby improving the low-temperature discharge performance of the electrochemical apparatus.

In some embodiments, F, A, and B satisfy the condition: 0.005≤F/(A+B)≤0.5. In some embodiments, 0.01≤F/(A+B)≤0.4. In some embodiments, 0.05≤F/(A+B)≤0.3. In some embodiments, 0.06≤F/(A+B)≤0.2. In some embodiments, 0.06≤F/(A+B)≤0.2. In some embodiments, the value of F/(A+B) is 0.005, 0.007, 0.03, 0.09, 0.12, 0.15, 0.2, 0.25, 0.45, 0.5, or a value within a range formed by any two of these values. By adjusting the fluorinated carbonate, lithium tetrafluoroborate, and the compound of Formula I in the electrolyte to satisfy the above condition range, the distribution of elements such as S, B, F, and P in the passivation layer formed at the electrode interface becomes more uniform, further increasing the ionic conductivity of the electrochemical apparatus and stabilizing the positive and negative electrode interfaces.

In some embodiments, the electrolyte further includes a cyclic sulfur-oxygen double bond compound, the cyclic sulfur-oxygen double bond compound including at least one of 1,3-propane sultone, ethylene sulfate, or methylene methanedisulfonate.

In some embodiments, based on the total mass of the electrolyte, the mass percentage of the cyclic sulfur-oxygen double bond compound is S, where S satisfies the condition: 0.01%≤S≤5.0%. In some embodiments, 0.2%≤S≤5.0%. In some embodiments, 0.4%≤S≤4.5%. In some embodiments, 0.3%≤S≤4.5%. In some embodiments, 0.2%≤S≤3.0%. In some embodiments, 3.0%≤S≤5.0%. In some embodiments, the value of S is 0.01%, 0.15%, 0.75%, 2.5%, 2.8%, 3.0%, 3.6%, 4.1%, 4.5%, 5.0%, or a value within a range formed by any two of these values. By selecting the cyclic sulfur-oxygen double bond compound to satisfy the above range, the cyclic sulfur-oxygen double bond compound can further enrich the components at the positive and negative electrode interfaces during the charge-discharge process, increasing the density of the passivation layer. Additionally, the cyclic sulfur-oxygen double bond compound, in combination with the compound of Formula I and lithium tetrafluoroborate, can improve the ionic conductivity of the electrolyte at low temperatures due to the solvation structure formed by the cyclic sulfur-oxygen double bond compound and the compound of Formula I with lithium ions.

In some embodiments, S, A, and B satisfy the condition: 0.003≤S/(A+B)≤0.5. In some embodiments, 0.005≤S/(A+B)≤0.4. In some embodiments, 0.01≤S/(A+B)≤0.3. In some embodiments, 0.01≤S/(A+B)≤0.2. In some embodiments, 0.008≤S/(A+B)≤0.2. In some embodiments, the value of S/(A+B) is 0.003, 0.004, 0.008, 0.01, 0.05, 0.3, 0.35, 0.5, or a value within a range formed by any two of these values. By adjusting the cyclic sulfur-oxygen double bond compound, lithium tetrafluoroborate, and the compound of Formula I in the electrolyte to satisfy the above condition range, the solvation structure formed by the cyclic sulfur-oxygen double bond compound, the compound of Formula I, and lithium tetrafluoroborate can improve the migration ability of lithium ions, and improving the conductivity of the electrolyte, thereby improving the low-temperature discharge performance of the electrochemical apparatus.

The electrolyte further includes a lithium salt. The present application imposes no particular restrictions on the type of lithium salt in the electrolyte, as long as it can achieve the purpose of the present application. For example, it may include, but is not limited to, at least one of lithium hexafluorosphate (LiPF₆), lithium tetrafluoroborate (LiBF₄), lithium difluorophosphate (LiPO₂F₂), lithium bis(trifluoromethanesulfonyl)imide (LiTFSI), lithium bis(fluorosulfonyl)imide (LiFSI), lithium bis(oxalate)borate (LiBOB), or lithium difluoro(oxalate)borate (LiDFOB). Based on the total mass of the electrolyte, the mass percentage of the lithium salt may be 8% to 15%. For example, the mass percentage of the lithium salt may be 8%, 9%, 10%, 11%, 12.5%, 13%, 15%, or a range formed by any two of these values.

The electrolyte may further include a non-aqueous solvent. The present application imposes no particular restrictions on the type of non-aqueous solvent in the electrolyte, as long as it can achieve the purpose of the present application. For example, it may include, but is not limited to, at least one of carbonate compounds, carboxylate compounds, ether compounds, or other organic solvents. The carbonate compounds may include, but are not limited to, at least one of linear carbonate compounds or cyclic carbonate compounds. The linear carbonate compounds may include, but are not limited to, at least one of dimethyl carbonate, propylene carbonate, ethylene carbonate, dipropyl carbonate, methyl propyl carbonate, ethyl propyl carbonate, or methyl ethyl carbonate. The cyclic carbonate compounds may include, but are not limited to, at least one of butylene carbonate or vinylethylene carbonate. The carboxylate compounds may include, but are not limited to, at least one of methyl formate, methyl acetate, ethyl acetate, n-propyl acetate, t-butyl acetate, methyl propionate, γ-butyrolactone, decalactone, valerolactone, or caprolactone. The ether compounds may include, but are not limited to, at least one of ethylene glycol dimethyl ether, dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents may include, but are not limited to, at least one of dimethyl sulfoxide, 1,2-dioxolane, sulfolane, methylsulfolane, 1,3-dimethyl-2-imidazolidinone, N-methyl-2-pyrrolidone, dimethylformamide, acetonitrile, trimethyl phosphate, triethyl phosphate, or trioctyl phosphate.

According to a second aspect, the present application provides an electrochemical apparatus, the electrochemical apparatus including the electrolyte as described above, the electrochemical apparatus further including a positive electrode, a negative electrode, and a separator.

The present application imposes no particular restrictions on the materials, structures, and processing methods of the positive electrode, negative electrode, and separator of the electrochemical apparatus, and any positive electrode, negative electrode, and separator applicable in the art are suitable for the present application.

### I. Positive Electrode

In the electrochemical apparatus of the present application, the positive electrode includes a positive electrode current collector and a positive electrode active material layer disposed on the surface of the positive electrode current collector. The positive electrode active material layer may be applied to a single surface of the positive electrode current collector to two surfaces of the positive electrode current collector.

The positive electrode material layer disposed on the same side of the positive electrode current collector may be one layer or multiple layers, and each layer of the multiple positive electrode material layers may contain the same or different positive electrode active materials. As the positive electrode active material used in the electrochemical apparatus, the positive electrode active material may include, but is not limited to, at least one of lithium nickel cobalt manganese oxide (for example, NCM811, NCM622, NCM523, and NCM111), lithium nickel cobalt aluminum oxide, lithium iron phosphate, lithium-rich manganese-based materials, lithium cobalt oxide (LiCoO₂), lithium manganese oxide, lithium manganese iron phosphate, or lithium titanate.

The positive electrode material layer of the present application further includes a conductive agent and a binder. The present application imposes no particular restrictions on the conductive agent and binder in the positive electrode material layer, as long as they can achieve the purpose of the present application. For example, the conductive agent may include, but is not limited to, at least one of conductive carbon black, carbon nanotubes (CNTs), carbon fibers, flake graphite, graphene, metal materials, or conductive polymers. The conductive carbon black may include, but is not limited to, Super P, acetylene black, or Ketjen black. The carbon nanotubes may include, but are not limited to, single-walled carbon nanotubes and/or multi-walled carbon nanotubes. The carbon fiber may include, but is not limited to, vapor-grown carbon fiber (VGCF) and/or carbon nanofiber. The metal material may include, but is not limited to, metal powder and/or metal fiber, and specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The binder may include, but is not limited to, at least one of polyacrylate, polyimide, polyamide, polyamide-imide, polyvinylidene fluoride, polystyrene-butadiene copolymer (styrene-butadiene rubber or SBR), sodium alginate, polyvinyl alcohol, polytetrafluoroethylene, polyacrylonitrile, sodium carboxymethyl cellulose (CMC-Na), potassium carboxymethyl cellulose, sodium hydroxymethyl cellulose, or potassium hydroxymethyl cellulose. The present application imposes no particular restrictions on the mass ratio of the positive electrode active material, conductive agent, and binder in the positive electrode material layer, and those skilled in the art may select according to actual needs, as long as they can achieve the purpose of the present application.

The present application imposes no particular restrictions on the positive electrode current collector, as long as it can achieve the purpose of the present application. For example, it may include aluminum foil, aluminum alloy foil, or a composite current collector (for example, an aluminum-carbon composite current collector). The present application imposes no particular restrictions on the thickness of the positive electrode current collector, as long as it can achieve the purpose of the present application. For example, the thickness of the positive electrode current collector is 5 μm to 20 μm, preferably 6 μm to 18 μm. The present application imposes no particular restrictions on the thickness of the positive electrode material layer, as long as it can achieve the purpose of the present application. For example, the thickness of the single-sided positive electrode material layer is 30 μm to 120 μm.

Optionally, the positive electrode may further include a conductive layer, the conductive layer being located between the positive electrode current collector and the positive electrode material layer. The present application imposes no particular restrictions on the composition of the conductive layer, which may be a conductive layer commonly used in the art. The conductive layer includes a conductive agent and a binder. The present application imposes no particular restrictions on the conductive agent and binder in the conductive layer, which may be at least one of the conductive agents and binders described above. The present application imposes no particular restrictions on the mass ratio of the conductive agent and binder in the conductive layer, and those skilled in the art may select according to actual needs, as long as they can achieve the purpose of the present application.

In the present application, the electrochemical apparatus further includes a negative electrode, the negative electrode including a negative electrode current collector and a negative electrode material layer disposed on at least one surface of the negative electrode current collector. The phrase “negative electrode material layer disposed on at least one surface of the negative electrode current collector” means that the negative electrode material layer may be disposed on one surface of the negative electrode current collector along its thickness direction, or on both surfaces of the negative electrode current collector along its thickness direction. It should be noted that the “surface” here may be the entire area of the negative electrode current collector or a partial area of the negative electrode current collector, and the present application imposes no particular restrictions, as long as it can achieve the purpose of the present application. The present application imposes no particular restrictions on the negative electrode current collector, as long as it can achieve the purpose of the present application. For example, it may include copper foil, copper alloy foil, nickel foil, stainless steel foil, titanium foil, nickel foam, copper foam, or a composite current collector.

The negative electrode material layer of the present application includes a negative electrode active material. The present application imposes no particular restrictions on the negative electrode active material, as long as it can achieve the purpose of the present application. For example, the negative electrode active material may include at least one of natural graphite, artificial graphite, mesocarbon microbeads (MCMB), hard carbon, soft carbon, silicon, silicon-carbon composites, SiOₓ (0.5<x<1.6), Li—Sn alloy, Li—Sn—O alloy, Sn, SnO, SnO₂, lithium titanate with a spinel structure Li₄Ti₅O₁₂, Li—Al alloy, or metallic lithium. The negative electrode material layer of the present application further includes a binder. The present application imposes no particular restrictions on the binder in the negative electrode material layer, as long as it can achieve the purpose of the present application. For example, the binder may be at least one of the binders described above. The negative electrode material layer of the present application further includes a conductive agent. The present application imposes no particular restrictions on the conductive agent in the negative electrode material layer, as long as it can achieve the purpose of the present application. For example, the conductive agent may be at least one of the conductive agents described above. The present application imposes no particular restrictions on the mass ratio of the negative electrode active material, binder, and conductive agent in the negative electrode material layer, and those skilled in the art may select according to actual needs, as long as they can achieve the purpose of the present application.

The present application imposes no particular restrictions on the thickness of the negative electrode current collector, as long as it can achieve the purpose of the present application. For example, the thickness of the negative electrode current collector is 5 μm to 16 μm. The present application imposes no particular restrictions on the thickness of the negative electrode material layer, as long as it can achieve the purpose of the present application. For example, the thickness of the single-sided negative electrode material layer is 30 μm to 120 μm.

Optionally, the negative electrode may further include a conductive layer, the conductive layer being located between the negative electrode current collector and the negative electrode material layer. The present application imposes no particular restrictions on the composition of the conductive layer, which may be a conductive layer commonly used in the art. The conductive layer includes a conductive agent and a binder. The present application imposes no particular restrictions on the conductive agent and binder in the conductive layer, which may be at least one of the conductive agents and binders described above. The present application imposes no particular restrictions on the mass ratio of the conductive agent and binder in the conductive layer, and those skilled in the art may select according to actual needs, as long as they can achieve the purpose of the present application. The present application imposes no particular restrictions on the thickness of the conductive layer, as long as it can achieve the purpose of the present application. For example, the thickness of the conductive layer is 1 μm to 10 μm.

In the present application, the electrochemical apparatus further includes a separator, the separator being used to separate the positive electrode plate and the negative electrode, preventing internal short circuits in the electrochemical apparatus, allowing electrolyte ions to pass freely, and not affecting the electrochemical charge-discharge process. The present application imposes no particular restrictions on the separator, as long as it can achieve the purpose of the present application. For example, the material of the separator may include, but is not limited to, at least one of polyolefins (PO) mainly composed of polyethylene (PE) or polypropylene (PP), polyesters (for example, polyethylene terephthalate (PET) film), cellulose, polyimide (PI), polyamide (PA), spandex, or aramid; and the type of separator may include at least one of woven membranes, non-woven membranes, microporous membranes, composite membranes, calendered membranes, or spun membranes. The present application imposes no particular restrictions on the thickness of the separator, as long as it can achieve the purpose of the present application. For example, the thickness of the separator is 3 μm to 30 μm.

In the present application, the separator may include a substrate and a surface treatment layer. The substrate may be a non-woven fabric or a composite membrane with a porous structure, and the material of the substrate may include at least one of polyethylene, polypropylene, polyethylene terephthalate, or polyimide. Optionally, a polypropylene porous membrane, a polyethylene porous membrane, a polypropylene non-woven fabric, a polyethylene non-woven fabric, or a polypropylene-polyethylene-polypropylene porous composite membrane may be used. Optionally, the thickness of the substrate is 3 μm to 25 μm. Optionally, at least one surface of the substrate is provided with a surface treatment layer, which may be a polymer layer, an inorganic layer, or a layer formed by mixing a polymer and an inorganic substance. For example, the inorganic layer includes inorganic particles and a binder. The present application imposes no particular restrictions on the inorganic particles, which may include, for example, at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The present application imposes no particular restrictions on the binder, which may be, for example, at least one of the binders described above. The polymer layer contains a polymer, and the material of the polymer includes at least one of polyamide, polyacrylonitrile, acrylate polymers, polyacrylic acid, polyvinylpyrrolidone, polyvinyl ether, polyvinylidene fluoride, or poly(vinylidene fluoride-hexafluoropropylene). Optionally, the thickness of the surface treatment layer is 1 μm to 10 μm.

The electrochemical apparatus of the present application further includes a packaging bag for accommodating the positive electrode plate, separator, negative electrode, and electrolyte, as well as other components known in the art for electrochemical apparatuses, and the present application imposes no restrictions on these other components. The present application imposes no particular restrictions on the packaging bag, which may be a packaging bag known in the art, as long as it can achieve the purpose of the present application.

The present application imposes no particular restrictions on the type of electrochemical apparatus, which may include any apparatus that undergoes an electrochemical reaction. In the present application, the electrochemical apparatus may include, but is not limited to, lithium metal electrochemical apparatuses, lithium-ion electrochemical apparatuses (lithium-ion batteries), lithium polymer electrochemical apparatuses, or lithium-ion polymer electrochemical apparatuses (lithium-ion polymer batteries).

The preparation process of the electrochemical apparatus of the present application is well known to those skilled in the art, and the present application imposes no particular restrictions. For example, it may include, but is not limited to, the following steps: stacking the positive electrode plate, separator, and negative electrode in order, and performing operations such as winding or folding as needed to obtain an electrode assembly with a wound structure, placing the electrode assembly in a packaging bag, injecting the electrolyte into the packaging bag, and sealing to obtain the electrochemical apparatus; alternatively, stacking the positive electrode plate, separator, and negative electrode in order, fixing the four corners of the entire stacked structure with tape to obtain an electrode assembly with a stacked structure, placing the electrode assembly in a packaging bag, injecting the electrolyte into the packaging bag, and sealing to obtain the electrochemical apparatus. Additionally, overcurrent protection elements, guide plates, and the like may be placed in the packaging bag as needed to prevent pressure buildup and overcharge-discharge within the electrochemical apparatus.

The present application further provides an electronic apparatus including the electrochemical apparatus according to any of these embodiments described above. Therefore, the electronic apparatus provided in the present application has good performance.

The type of electronic apparatus is not particularly limited in the present application, and the electronic apparatus may be any known electronic apparatus used in the prior art. In some embodiments, the electronic apparatus may include, but is not limited to, a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

Below, specific examples are provided to illustrate the preparation of the electrochemical apparatus of the present application, and those skilled in the art will understand that the preparation methods described in the present application are merely examples, and any other suitable preparation methods are within the scope of the present application.

### EXAMPLES

Below, taking a lithium-ion battery as an example, examples and comparative examples are provided to more specifically illustrate the embodiments of the electrochemical apparatus of the present application. Those skilled in the art will understand that the preparation methods described in the present application are merely examples, and any other suitable preparation methods are within the scope of the present application. Various tests and evaluations were conducted according to the methods described below. In addition, unless otherwise specified, “part” and “%” were based on weight.

### Test Methods

### 1. Impedance Test Method at 50% SOC at −10° C.

At a temperature of 25° C., a lithium-ion battery was discharged at a current of 0.5 C to 3.0 V and left standing for 5 minutes. Subsequently, the battery was charged at a current of 0.5 C to 4.5V and maintained at a constant voltage of 4.5V until the current reached 0.025 C. After left standing for 5 minutes, the battery was discharged at a current of 0.1 C to 3.0 V, and the capacity discharged at this point was recorded as C1. The battery was then charged at a capacity of 0.5 C1 to 4.5V and maintained at a constant voltage of 4.5V until the current reached 0.025 C1, followed by standing for 5 minutes. At a temperature of −10° C., the lithium-ion battery was discharged at a current of 0.1 C1 for 5 h, with the battery voltage recorded as V1. Subsequently, the battery was discharged at a current of 1 C for 1 second, and the battery voltage was recorded as V2.

The impedance at 50% SOC at −10° C.=(V1−V2)/(1 C−0.1 C1).

### 2. Low-Temperature Discharge Performance Test Method

A lithium-ion battery was placed in a constant temperature environment of 25° C. and left standing for 30 min to reach a constant temperature state of 25° C. The battery was charged at a constant current of 0.5 C to 4.5V, maintained at a constant voltage of 4.5V until the current reached 0.025 C, and discharged at a constant current of 0.2 C to 3.0 V. The discharge capacity at 25° C. was recorded as C2. The battery was then charged at a constant current of 0.5 C to 4.5V, maintained at a constant voltage of 4.5V until the current reached 0.025 C, and transferred to a −10° C. constant temperature test chamber. After left standing for 60 min to reach a constant temperature state of −10° C., the battery was discharged at a constant current of 0.2 C to 3.0V, and the discharge capacity at −10° C. was recorded as C3.

The low-temperature discharge capacity retention rate at −10° C.=C3/C2×100%.

### Example 1-1

### 1. Preparation of Positive Electrode Plate

A positive electrode active material LiCoO₂, a positive electrode conductive agent conductive carbon black (Super P), and a positive electrode binder polyvinylidene fluoride (PVDF, Mw=7×10⁶) were mixed at a mass ratio of 97.5:1:1.5. N-methylpyrrolidone (NMP) was added as a solvent, and the mixture was stirred well under the action of a vacuum mixer to obtain a positive electrode slurry with a solid content of 75 wt %. The positive electrode slurry was uniformly applied to one surface of a positive electrode current collector aluminum foil with a thickness of 10 μm, dried at 85° C., and cold-pressed to obtain a positive electrode plate with a single-sided coating thickness of 50 μm for the positive electrode material layer. The same steps were repeated on the other surface of the aluminum foil to obtain a positive electrode plate with double-sided coating of the positive electrode material layer. The plate was then cut, and a positive electrode tab, that is, an aluminum tab was welded to obtain a positive electrode plate with specifications of 74 mm×851 mm for use, with a compacted density of the positive electrode material layer of 4.15 g/cm³.

### 2. Preparation of Negative Electrode Plate

A negative electrode active material artificial graphite, a negative electrode conductive agent Super P, a thickener sodium carboxymethyl cellulose (CMC-Na, Mw=7×10⁵), and a negative electrode binder styrene-butadiene rubber (SBR, Mw=5×10⁶) were mixed at a mass ratio of 97.5:1:0.5:1. Deionized water was added as a solvent, and the mixture was stirred well under the action of a vacuum mixer to obtain a negative electrode slurry with a solid content of 50 wt %. The negative electrode slurry was uniformly applied to one surface of a negative electrode current collector copper foil with a thickness of 8 μm, dried at 85° C., and cold-pressed to obtain a negative electrode plate with a single-sided coating thickness of 60 μm for the negative electrode material layer. The same steps were repeated on the other surface of the copper foil to obtain a negative electrode plate with double-sided coating of the negative electrode material layer. The plate was then cut, and a negative electrode tab, that is, a nickel tab was welded to obtain a negative electrode plate with specifications of 76 mm×867 mm for use, with a compacted density of the negative electrode material layer of 1.75 g/cm³.

### 3. Preparation of Electrolyte

In an argon atmosphere glovebox with a water content of less than 10 ppm, dimethyl carbonate, propylene carbonate, and ethylene carbonate were mixed at a mass ratio of 60:30:10 to obtain a base solvent. Lithium tetrafluoroborate, a compound of Formula I, and lithium hexafluorophosphate (LiPF₆) were dissolved in the base solvent to obtain an electrolyte. Based on the total mass of the electrolyte, the mass percentage of LiPF₆ was 12.5%.

The mass percentages of lithium tetrafluoroborate and the compound of Formula I are as shown in Table 1, with the remainder being the base solvent.

### 4. Separator

A polyethylene (PE) porous membrane with a thickness of 15 μm was used.

### 5. Preparation of Lithium-Ion Battery

The separator, positive electrode plate, separator, and negative electrode plate prepared above were stacked in order and wound to obtain an electrode assembly with a wound structure. The electrode assembly was placed in an aluminum-plastic film packaging bag, and after drying, the electrolyte was injected. Processes such as vacuum sealing, standing, formation (charged at 0.2 C constant current to 3.5V, then charged at 1 C constant current to 3.9V), capacity testing, degassing, and trimming were performed to obtain a lithium-ion battery.

Examples 1-2 to 1-17 were the same as Example 1-1, except for the preparation of the electrolyte, where the type and percentage B of the compound of Formula I and the percentage A of lithium tetrafluoroborate were adjusted as shown in Table 1. The mass percentage of the base solvent was changed accordingly, while the mass percentage of the lithium salt remained unchanged.

Comparative Example 1-1 was the same as Example 1-1, except for not adding the compound of Formula I in the electrolyte. The mass percentage of the base solvent was changed accordingly, while the mass percentage of the lithium salt remained unchanged.

Comparative Example 1-2 was the same as Example 1-1, except for not adding lithium tetrafluoroborate in the electrolyte. The mass percentage of the base solvent was changed accordingly, while the mass percentage of the lithium salt remained unchanged.

Comparative Examples 1-3 to 1-6 were the same as Example 1-1, except for the preparation of the electrolyte, where the percentage B of the compound of Formula I and the percentage A of lithium tetrafluoroborate were adjusted as shown in Table 1. The mass percentage of the base solvent was changed accordingly, while the mass percentage of the lithium salt remained unchanged.

Examples 2-1 to 2-7 were the same as Example 1-4, except for the preparation of the electrolyte, where the compound of Formula II was added as shown in Table 2. The mass percentage of the base solvent was changed accordingly, while the mass percentage of the lithium salt remained unchanged.

Examples 3-1 to 3-6 were the same as Example 1-4, except for the preparation of the electrolyte, where the fluorinated carbonate was added as shown in Table 3. The mass percentage of the base solvent was changed accordingly, while the mass percentage of the lithium salt remained unchanged.

Examples 3-7 and 3-8 were the same as Example 1-4, except for the preparation of the electrolyte, where the compound of Formula II and the fluorinated carbonate were added as shown in Table 3. The mass percentage of the base solvent was changed accordingly, while the mass percentage of the lithium salt remained unchanged.

Examples 4-1 to 4-4 were the same as Example 1-4, except for the preparation of the electrolyte, where the cyclic sulfur-oxygen double bond compound was added as shown in Table 4. The mass percentage of the base solvent was changed accordingly, while the mass percentage of the lithium salt remained unchanged.

Examples 4-5 and 4-6 were the same as Example 1-4, except for the preparation of the electrolyte, where the cyclic sulfur-oxygen double bond compound and the compound of Formula II were added as shown in Table 4. The mass percentage of the base solvent was changed accordingly, while the mass percentage of the lithium salt remained unchanged.

Examples 4-7 and 4-8 were the same as Example 1-4, except for the preparation of the electrolyte, where the cyclic sulfur-oxygen double bond compound and the fluorinated carbonate were added as shown in Table 4. The mass percentage of the base solvent was changed accordingly, while the mass percentage of the lithium salt remained unchanged.

Examples 4-9 and 4-10 were the same as Example 1-4, except for the preparation of the electrolyte, where the cyclic sulfur-oxygen double bond compound, the fluorinated carbonate, and the compound of Formula II were added as shown in Table 4. The mass percentage of the base solvent was changed accordingly, while the mass percentage of the lithium salt remained unchanged.

The preparation parameters and performance parameters of Examples 1-1 to 1-17 and Comparative Examples 1-1 to 1-6 are shown in Table 1.

TABLE 1

| | | Type of | | | | −10° C. low- |
|---|---|---|---|---|---|---|
| | Percentage A of | compound of | | | −10° C. 50% | temperature |
| | lithium | Formula I | Percentage B of | | SOC | discharge |
| | tetrafluoroborate | (mass | compound of | | impedance | capacity retention |
| Item | (%) | percentage %) | Formula I (%) | B/A | (mΩ) | rate (%) |
| Comparative | 0.20 | / | / | / | 123.5 | 78.9 |
| Example 1-1 | | | | | | |
| Comparative | / | I-1 | 10.00 | / | 105 | 80.3 |
| Example 1-2 | | | | | | |
| Comparative | 0.09 | I-1 | 10.00 | 111.11 | 103 | 73.5 |
| Example 1-3 | | | | | | |
| Comparative | 2.50 | I-1 | 10.00 | 4.00 | 135 | 83.5 |
| Example 1-4 | | | | | | |
| Comparative | 0.20 | I-1 | 0.005 | 0.03 | 119 | 79.7 |
| Example 1-5 | | | | | | |
| Comparative | 0.20 | I-1 | 20.50 | 102.50 | 129 | 80.2 |
| Example 1-6 | | | | | | |
| Example 1-1 | 0.10 | I-1 | 10.00 | 100.00 | 93 | 85.2 |
| Example 1-2 | 0.15 | I-1 | 10.00 | 66.67 | 89 | 89.3 |
| Example 1-3 | 0.19 | I-1 | 10.00 | 52.63 | 87 | 92.4 |
| Example 1-4 | 0.20 | I-1 | 10.00 | 50.00 | 79 | 96.3 |
| Example 1-5 | 1.10 | I-1 | 10.00 | 20.00 | 85 | 95.4 |
| Example 1-6 | 1.80 | I-1 | 10.00 | 6.67 | 88 | 92.8 |
| Example 1-7 | 0.20 | I-1 | 0.01 | 0.05 | 103 | 83.6 |
| Example 1-8 | 0.20 | I-1 | 1.22 | 6.10 | 98 | 85.5 |
| Example 1-9 | 0.20 | I-2 | 2.20 | 11.00 | 90 | 89 |
| Example 1-11 | 0.20 | I-1 | 5.00 | 25.00 | 85 | 90.3 |
| Example 1-12 | 0.20 | I-1 | 11.00 | 55.00 | 83 | 92.6 |
| Example 1-13 | 0.20 | I-1 | 15.00 | 75.00 | 85 | 88.9 |
| Example 1-14 | 0.20 | I-1 | 19.88 | 99.40 | 88 | 87.1 |
| Example 1-15 | 0.20 | I-1 (2.0) + I-8 | 11.00 | 55.00 | 83 | 91.7 |
| | | (1.0) + I-17 (8) | | | | |
| Example 1-16 | 0.20 | I-3 (8.0) + I-17 | 18.00 | 90.00 | 87 | 90.8 |
| | | (10.0) | | | | |
| Example 1-17 | 0.20 | I-4 (1.0) + I-11 | 15.00 | 75.00 | 85 | 92.5 |
| | | (14.0) | | | | |

Note:
“/” in Table 1 indicates no corresponding parameter.

From Examples 1-1 to 1-17 and Comparative Examples 1-1 to 1-6 in Table 1, it can be seen that the inclusion of the compound of Formula I and lithium tetrafluoroborate in the electrolyte can effectively improve the low-temperature impedance of the electrochemical apparatus. Moreover, the compound of Formula I and lithium tetrafluoroborate can form a passivation layer rich in elements such as B, P, and S at the positive electrode interface, reducing interface impedance while also improving the low-temperature discharge performance of the electrochemical apparatus.

From Examples 1-1 to 1-6 and Comparative Examples 1-3 and 1-4, it can be seen that the mass percentage A of lithium tetrafluoroborate satisfying 0.1%≤A≤2% can effectively improve the low-temperature impedance performance of the electrochemical apparatus. When A is below the lower limit of 0.3%, it is difficult to achieve the effect of enhancing interface stability. When A is above the upper limit of 10%, lithium tetrafluoroborate cannot be fully ionized, reducing the conductivity of the electrolyte, and severely worsening the impedance of the lithium-ion battery.

From Examples 1-7 to 1-17 and Comparative Examples 1-5 and 1-6, it can be seen that the mass percentage B of the compound of Formula I satisfying 0.01%≤B≤20% can effectively improve the low-temperature interface impedance performance of the electrochemical apparatus. When B is below the lower limit of 1%, it is similarly difficult to achieve the effect of interface modification. When B exceeds the upper limit of 30%, the thickness of the formed passivation layer increases and becomes loose, reducing ionic conductivity and worsening the impedance of the lithium-ion battery.

From Examples 1-1 to 1-17, it can be seen that when A and B satisfy 15≤B/A≤70, the passivation layer formed by the compound of Formula I and lithium tetrafluoroborate can improve the conductivity of lithium ions, thereby effectively improving the low-temperature discharge performance of the lithium-ion battery.

The preparation parameters and performance parameters of Example 1-4 and Examples 2-1 to 2-7 are shown in Table 2.

TABLE 2

| | | | | Type of | | | −10° C. low- |
|---|---|---|---|---|---|---|---|
| | | | Percentage | compound | Percentage | | temperature |
| | Percentage A of | Type of | B of | of Formula | C of | −10° C. | discharge |
| | lithium | compound | compound | II (mass | compound | 50% SOC | capacity |
| | tetrafluoroborate | of Formula | of Formula | percentage | of Formula | impedance | retention rate |
| Item | (%) | I | I (%) | %) | II (%) | (mΩ) | (%) |
| Example 1-4 | 0.2 | I-1 | 10 | / | / | 79 | 96.3 |
| Example 2-1 | 0.2 | I-1 | 10 | II-1 | 0.50 | 78 | 96.9 |
| Example 2-2 | 0.2 | I-1 | 10 | II-1 | 5.50 | 73 | 96.5 |
| Example 2-3 | 0.2 | I-1 | 10 | II-1 | 12.50 | 70 | 97.2 |
| Example 2-4 | 0.2 | I-1 | 10 | II-1 | 18.40 | 71 | 97.0 |
| Example 2-5 | 0.2 | I-1 | 10 | II-1 | 19.50 | 72 | 96.3 |
| Example 2-6 | 0.2 | I-1 | 10 | II-2 (4) + | 8.00 | 73 | 97.3 |
| | | | | II-5 (4) | | | |
| Example 2-7 | 0.2 | I-1 | 10 | II-7 (2) + | 8.00 | 75 | 97.2 |
| | | | | II-10 (6) | | | |

Note:
“/” in Table 2 indicates no corresponding parameter.

From Example 1-4 and Examples 2-1 to 2-7 in Table 2, it can be seen that by introducing the compound of Formula II into the electrolyte, with the percentage C of the compound of Formula II satisfying 0.1%≤C≤20%, the viscosity of the electrolyte can be reduced, while also helping to improve the dissociation of the lithium salt, thereby further effectively improving the low-temperature impedance performance of the electrochemical apparatus.

The preparation parameters and performance parameters of Example 1-4 and Examples 3-1 to 3-8 are shown in Table 2.

TABLE 3

| | | | | | | | | | −10° C. low- |
|---|---|---|---|---|---|---|---|---|---|
| | | Percentage | Type of | Percentage | | Percentage | | | temperature |
| | Percentage A of | B of | compound | C of | Type of | F of | | −10° C. | discharge |
| | lithium | compound | of | compound | fluorinated | fluorinated | | 50% SOC | capacity |
| | tetrafluoroborate | of Formula | Formula | of Formula | carbonate (mass | carbonate | | impedance | retention |
| Item | (%) | I (%) | II | II (%) | percentage %) | (%) | F/(A + B) | (mΩ) | rate (%) |
| Example | 0.2 | 10 | / | / | / | / | / | 79 | 96.3 |
| 1-4 | | | | | | | | | |
| Example | 0.2 | 10 | / | / | Fluoroethylene | 0.08 | 0.01 | 67 | 97.1 |
| 3-1 | | | | | carbonate | | | | |
| Example | 0.2 | 10 | / | / | Fluoroethylene | 0.18 | 0.02 | 70 | 97.2 |
| 3-2 | | | | | carbonate | | | | |
| Example | 0.2 | 10 | / | / | Fluoroethylene | 0.69 | 0.07 | 72 | 96.9 |
| 3-3 | | | | | carbonate | | | | |
| Example | 0.2 | 10 | / | / | Fluoroethylene | 2.36 | 0.23 | 76 | 97.2 |
| 3-4 | | | | | carbonate | | | | |
| Example | 0.2 | 10 | / | / | Fluoroethylene | 0.50 | 0.05 | 74 | 97.0 |
| 3-5 | | | | | carbonate | | | | |
| | | | | | (0.25) + | | | | |
| | | | | | difluoroethylene | | | | |
| | | | | | carbonate (0.25) | | | | |
| Example | 0.2 | 10 | / | / | Difluoroethylene | 0.50 | 0.05 | 77 | 97.3 |
| 3-6 | | | | | carbonate (0.1) + | | | | |
| | | | | | 3,3,3- | | | | |
| | | | | | trifluoropropylene | | | | |
| | | | | | carbonate (0.4) | | | | |
| Example | 0.2 | 10 | II-1 | 8.00 | Fluoroethylene | 0.13 | 0.01 | 69 | 97.9 |
| 3-7 | | | | | carbonate | | | | |
| Example | 0.2 | 10 | II-5 | 8.50 | Fluoroethylene | 0.25 | 0.02 | 68 | 97.8 |
| 3-8 | | | | | carbonate | | | | |

Note:
“/” in Table 3 indicates no corresponding parameter.

From Example 1-4 and Examples 3-1 to 3-8 in Table 3, it can be seen that by introducing the fluorinated carbonate into the electrolyte, with the percentage F of the fluorinated carbonate satisfying 0.01%≤F≤5% and 0.005≤F/(A+B)≤0.5, the low-temperature impedance and low-temperature discharge performance of the lithium-ion battery can be effectively improved. This is because the fluorinated carbonate can improve the dissociation ability of the lithium salt, increasing the ionic conductivity of the electrolyte. However, a too low percentage of fluorinated carbonate has limited dissociation ability, and a too high percentage of fluorinated carbonate increases the viscosity of the electrolyte. When the percentages of the compound of Formula I, lithium tetrafluoroborate, and fluorinated carbonate are within the above ranges, the conductivity of the electrolyte can be improved while optimizing the components of the passivation layer, forming a low-impedance passivation layer, thereby simultaneously achieving the effect of optimizing low-temperature impedance and low-temperature discharge performance.

The preparation parameters and performance parameters of Example 1-4 and Examples 4-1 to 4-10 are shown in Table 4.

TABLE 4

| | | Percentage | | Percentage | | Percentage |
|---|---|---|---|---|---|---|
| | Percentage A | B of | Type of | C of | | F of |
| | of lithium | compound | compound | compound | Type of | fluorinated |
| | tetrafluoro- | of Formula I | of Formula | of Formula | fluorinated | carbonate |
| Item | borate (%) | (%) | II | II (%) | carbonate | (%) |
| Example | 0.2 | 10 | / | / | / | / |
| 1-4 | | | | | | |
| Example | 0.2 | 10 | / | / | / | / |
| 4-1 | | | | | | |
| Example | 0.2 | 10 | / | / | / | / |
| 4-2 | | | | | | |
| Example | 0.2 | 10 | / | / | / | / |
| 4-3 | | | | | | |
| Example | 0.2 | 10 | / | / | / | / |
| 4-4 | | | | | | |
| Example | 0.2 | 10 | II-1 | 8.00 | / | / |
| 4-5 | | | | | | |
| Example | 0.2 | 10 | II-1 | 8.25 | / | / |
| 4-6 | | | | | | |
| Example | 0.2 | 10 | / | / | Fluoroethylene | 0.13 |
| 4-7 | | | | | carbonate | |
| Example | 0.2 | 10 | / | / | Fluoroethylene | 0.32 |
| 4-8 | | | | | carbonate | |
| Example | 0.2 | 10 | II-1 | 8.50 | Fluoroethylene | 1.60 |
| 4-9 | | | | | carbonate | |
| Example | 0.2 | 10 | II-1 | 8.80 | Fluoroethylene | 2.70 |
| 4-10 | | | | | carbonate | |

| | | Percentage | | | −10° C. low- |
|---|---|---|---|---|---|
| | Type of cyclic | S of cyclic | | | temperature |
| | sulfur-oxygen | sulfur- | | −10° C. | discharge |
| | double bond | oxygen | | 50% SOC | capacity |
| | compound (mass | double bond | | impedance | retention |
| Item | percentage %) | compound (%) | S/(A + B) | (mΩ) | rate (%) |
| Example | / | / | / | 79 | 96.3 |
| 1-4 | | | | | |
| Example | Ethylene sulfate | 0.03 | 0.00 | 73 | 97.0 |
| 4-1 | | | | | |
| Example | Ethylene sulfate | 0.50 | 0.05 | 70 | 97.2 |
| 4-2 | | | | | |
| Example | Ethylene sulfate | 3.99 | 0.39 | 62 | 97.3 |
| 4-3 | | | | | |
| Example | Ethylene sulfate | 5.00 | 0.49 | 65 | 97.1 |
| 4-4 | | | | | |
| Example | Ethylene sulfate | 3.00 | 0.29 | 57 | 98 |
| 4-5 | (1.5) + 1,3- | | | | |
| | propane sultone | | | | |
| | (1.5) | | | | |
| Example | 1,3-propane | 3.00 | 0.29 | 59 | 98.2 |
| 4-6 | sultone (1.2) + | | | | |
| | methylene | | | | |
| | methanedi- | | | | |
| | sulfonate (1.8) | | | | |
| Example | Ethylene sulfate | 0.12 | 0.01 | 56 | 98.0 |
| 4-7 | | | | | |
| Example | Ethylene sulfate | 0.15 | 0.01 | 58 | 98.3 |
| 4-8 | | | | | |
| Example | Ethylene sulfate | 1.70 | 0.17 | 51 | 99.1 |
| 4-9 | | | | | |
| Example | Ethylene sulfate | 2.50 | 0.25 | 53 | 98.7 |
| 4-10 | | | | | |

Note:
“/” in Table 4 indicates no corresponding parameter.

From Example 1-4 and Examples 4-1 to 4-4 in Table 4, it can be seen that with the percentage S of the cyclic sulfur-oxygen double bond compound satisfying 0.01%≤S≤5.0% and 0.003≤S/(A+B)≤0.5, the cyclic sulfur-oxygen double bond compound can further enrich the components at the positive and negative electrode interfaces, increasing the density of the passivation layer, thereby effectively improving the low-temperature impedance performance and low-temperature discharge performance of the electrochemical apparatus. When S is below the above range, the improvement in low-temperature impedance and low-temperature discharge performance of the electrochemical apparatus is not significant. When S is above the above range, the conductivity of the electrolyte decreases, resulting in suboptimal improvement in the low-temperature impedance performance of the electrochemical apparatus.

From Examples 4-5 and 4-6 as well as Examples 4-9 and 4-10 in Table 4, it can be seen that by adding the cyclic sulfur-oxygen double bond compound to the electrolyte, the cyclic sulfur-oxygen double bond compound can combine with the compound of Formula I and the compound of Formula II to form a solvation structure, promoting the transport of lithium ions, thereby further improving the low-temperature discharge performance of the electrochemical apparatus.

Both the compound of Formula II and the fluorinated carbonate can enhance the dissociation ability of the lithium salt. From Examples 4-5 to 4-10, it can be seen that the compound of Formula II and the fluorinated carbonate, by combining with the cyclic sulfur-oxygen double bond compound, can further improve the low-temperature impedance performance of the electrochemical apparatus.

It should be noted that, in this document, relational terms such as first and second are used solely to distinguish one entity or operation from another entity or operation, without necessarily requiring or implying any actual such relationship or order between such entities or operations. Additionally, the terms “include,” “comprise,” or any of their variants are intended to cover a non-exclusive inclusion, such that a process, method, or article that includes a series of elements includes not only those elements but also other elements that are not expressly listed, or further includes elements inherent to such process, method, or article.

Some embodiments in this specification are described in a related manner. For a part that is the same or similar between different embodiments, reference may be made between these embodiments. Each embodiment focuses on differences from other embodiments.

The foregoing descriptions are merely preferred embodiments of the present application and are not intended to limit the present application. Any modifications, equivalent replacements, improvements, and the like made without departing from the spirit and principle of the present application shall fall within the protection scope of the present application.

What is claimed is:

1. An electrolyte comprising lithium tetrafluoroborate and a compound of Formula I; 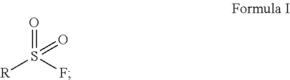
wherein R in the compound of Formula I is selected from unsubstituted or Ra-substituted C₂-C₆ alkyl, unsubstituted or Ra-substituted C₂-C₆ alkenyl, unsubstituted or Ra-substituted C₂-C₆ alkynyl, unsubstituted or Ra-substituted C₂-C₆ nitrogen-containing heteroaryl, or unsubstituted or Ra-substituted C₆-C₁₂ aryl, wherein each group substituent Ra is independently selected from fluorine or C₁-C₆ fluoroalkyl; and
based on a total mass of the electrolyte, a mass percentage of the lithium tetrafluoroborate is A, and a mass percentage of the compound of Formula I is B, wherein 0.1%≤A≤2%, and 0.01%≤B≤20%.

2. The electrolyte according to claim 1, wherein the electrolyte satisfies at least one of the following conditions:

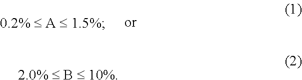

3. The electrolyte according to claim 1, wherein 15≤B/A≤70.

4. The electrolyte according to claim 2, wherein 15≤B/A≤70.

5. The electrolyte according to claim 1, wherein the compound of Formula I comprises at least one of the following compounds:

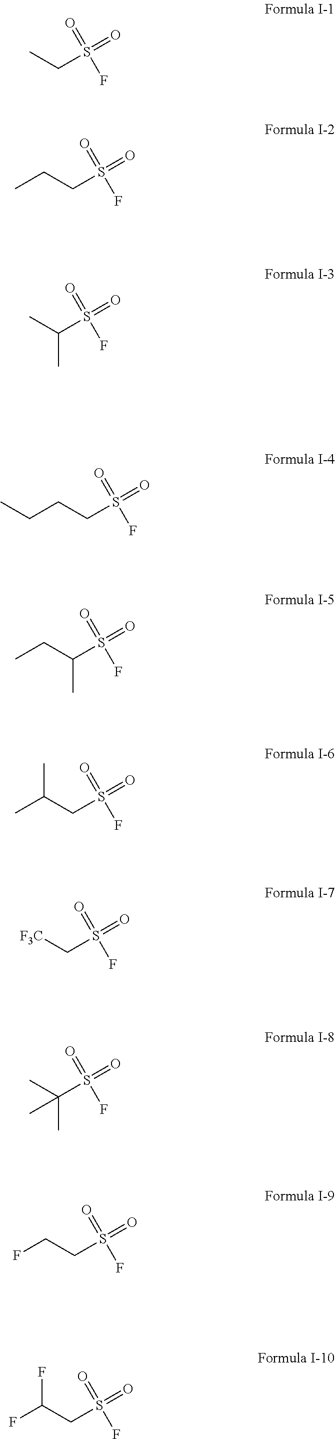

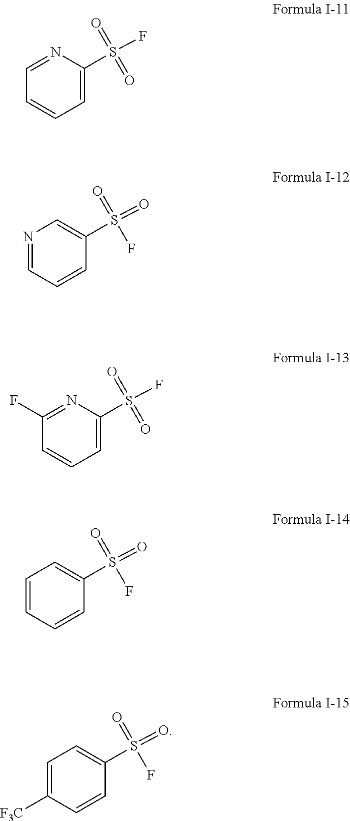 [SMILES: O=S(=O)(F)c1ccccn1 ; O=S(=O)(F)c1cccnc1 ; O=S(=O)(F)c1cccc(F)n1 ; O=S(=O)(F)c1ccccc1 ; O=S(=O)(F)c1ccc(C(F)(F)F)cc1]

6. The electrolyte according to claim 1, wherein the electrolyte further comprises a compound of Formula II, the compound of Formula II comprising at least one of the following compounds

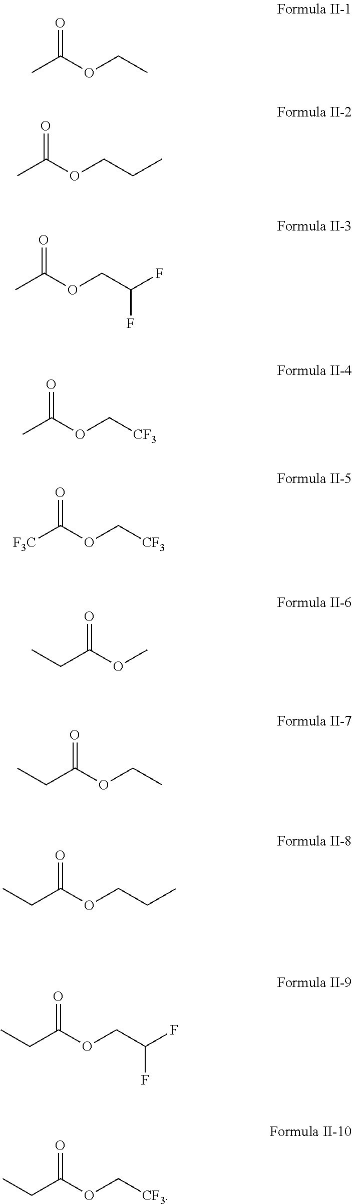

7. The electrolyte according to claim 6, wherein, based on the total mass of the electrolyte, a mass percentage of the compound of Formula II is C, wherein 0.1%≤C≤20%.

8. The electrolyte according to claim 1, wherein the electrolyte further comprises a fluorinated carbonate; the fluorinated carbonate comprising at least one of fluoroethylene carbonate, difluoroethylene carbonate, or 3,3,3-trifluoropropylene carbonate; wherein
based on the total mass of the electrolyte, a mass percentage of the fluorinated carbonate is F, wherein 0.0100≤F≤500 and 0.005≤F/(A+B)≤0.5.

9. The electrolyte according to claim 1, wherein the electrolyte further comprises a cyclic sulfur-oxygen double bond compound; the cyclic sulfur-oxygen double bond compound comprising at least one of 1,3-propane sultone, ethylene sulfate, or methylene methanedisulfonate; wherein
based on the total mass of the electrolyte, a mass percentage of the cyclic sulfur-oxygen double bond compound is S, wherein 0.01%≤S≤5.0%, and 0.003≤S/(A+B)≤0.5.

10. An electrochemical apparatus comprising an electrolyte, the electrolyte comprises lithium tetrafluoroborate and a compound of Formula I; 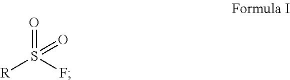
wherein R in the compound of Formula I is selected from unsubstituted or Ra-substituted C₂-C₆ alkyl, unsubstituted or Ra-substituted C₂-C₆ alkenyl, unsubstituted or Ra-substituted C₂-C₆ alkynyl, unsubstituted or Ra-substituted C₂-C₆ nitrogen-containing heteroaryl, or unsubstituted or Ra-substituted C₆-C₁₂ aryl, wherein each group substituent Ra is independently selected from fluorine or C₁-C₆ fluoroalkyl; and
based on a total mass of the electrolyte, a mass percentage of the lithium tetrafluoroborate is A, and a mass percentage of the compound of Formula I is B, wherein 0.1%≤A≤2%, and 0.01%≤B≤20%.

11. The electrochemical apparatus according to claim 10, wherein the electrolyte satisfies at least one of the following conditions:

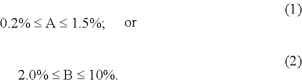

12. The electrochemical apparatus according to claim 10, wherein 15≤B/A≤70.

13. The electrochemical apparatus according to claim 11, wherein 15≤B/A≤70.

14. The electrochemical apparatus according to claim 10, wherein the compound of Formula I comprises at least one of the following compounds:

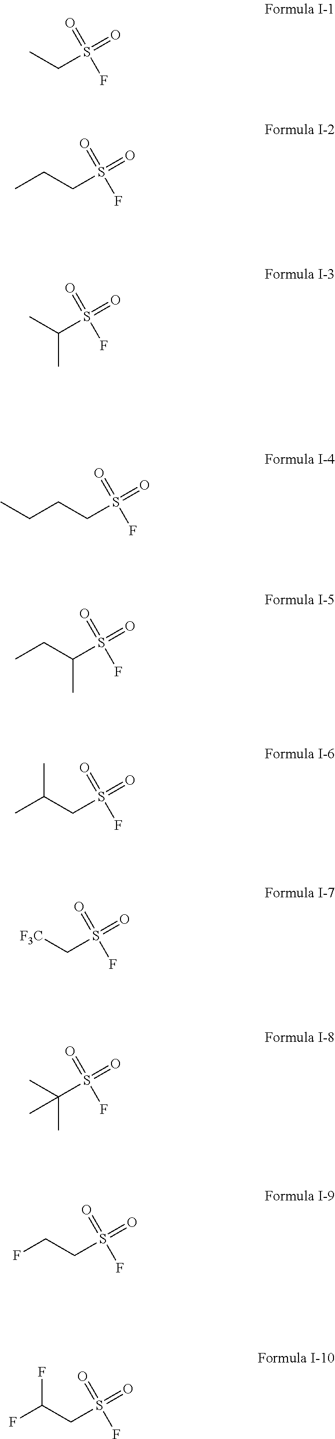

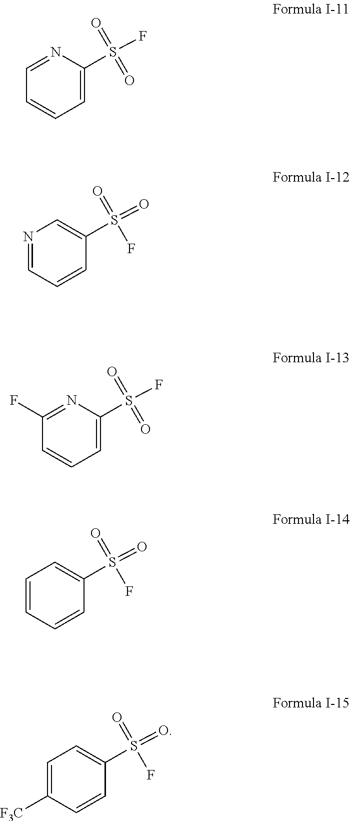 [SMILES: O=S(=O)(F)c1ccccn1 ; O=S(=O)(F)c1cccnc1 ; O=S(=O)(F)c1cccc(F)n1 ; O=S(=O)(F)c1ccccc1 ; O=S(=O)(F)c1ccc(C(F)(F)F)cc1]

15. The electrochemical apparatus according to claim 10, wherein the electrolyte further comprises a compound of Formula II, the compound of Formula II comprising at least one of the following compounds:

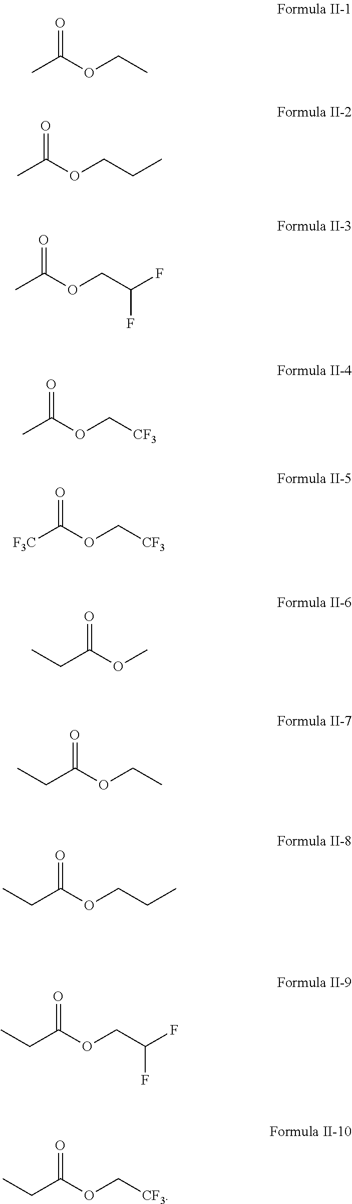

16. The electrochemical apparatus according to claim 15, wherein, based on the total mass of the electrolyte, a mass percentage of the compound of Formula II is C, wherein 0.1%≤C≤20%.

17. The electrochemical apparatus according to claim 10, wherein the electrolyte further comprises a fluorinated carbonate, the fluorinated carbonate comprising at least one of fluoroethylene carbonate, difluoroethylene carbonate, or 3,3,3-trifluoropropylene carbonate; wherein
based on the total mass of the electrolyte, a mass percentage of the fluorinated carbonate is F, wherein 0.01%≤F≤5%, and 0.005≤F/(A+B)≤0.5.

18. The electrochemical apparatus according to claim 10, wherein the electrolyte further comprises a cyclic sulfur-oxygen double bond compound, the cyclic sulfur-oxygen double bond compound comprising at least one of 1,3-propane sultone, ethylene sulfate, or methylene methanedisulfonate; wherein
based on the total mass of the electrolyte, a mass percentage of the cyclic sulfur-oxygen double bond compound is S, wherein 0.01%≤S≤5.0%, and 0.003≤S/(A+B)≤0.5.

19. An electronic apparatus comprising an electrochemical apparatus, comprising an electrolyte, the electrolyte comprises lithium tetrafluoroborate and a compound of Formula I; 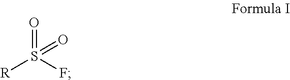
wherein R in the compound of Formula I is selected from unsubstituted or Ra-substituted C₂-C₆ alkyl, unsubstituted or Ra-substituted C₂-C₆ alkenyl, unsubstituted or Ra-substituted C₂-C₆ alkynyl, unsubstituted or Ra-substituted C₂-C₆ nitrogen-containing heteroaryl, or unsubstituted or Ra-substituted C₆-C₁₂ aryl, wherein each group substituent Ra is independently selected from fluorine or C₁-C₆ fluoroalkyl; and
based on a total mass of the electrolyte, a mass percentage of the lithium tetrafluoroborate is A, and a mass percentage of the compound of Formula I is B, wherein 0.1%≤A≤2%, and 0.01%≤B≤20%.

20. The electronic apparatus according to claim 19, wherein the electrolyte satisfies at least one of the following conditions: [chemical structure]
